(19) United States
(12) Patent Application Publication
(10) Pub. No.: US 2012/0281737 A1
(43) Pub. Date: Nov. 8, 2012

(54) WIRELESS COMMUNICATIONS INCLUDING DISTRIBUTED FEEDBACK ARCHITECTURE

(76) Inventors: Liang Hung, Short Hills, NJ (US); Michael Hodgetts, Long Valley, NJ (US)

(21) Appl. No.: 13/101,419

(22) Filed: May 5, 2011

(51) Int. Cl. H04L 5/16

(52) U.S. Cl. 375/219

(57) ABSTRACT

An exemplary wireless communication device includes a plurality of amplifiers that each provide an output signal. A combiner combines the output signals into a combined signal. A pre-distortion processor is configured to provide signal correction for each of the amplifiers. The pre-distortion processor receives feedback comprising an indication of each of the output signals before the output signals are combined into the combined signal.

### FIELD OF THE INVENTION

This invention generally relates to communication. More particularly, this invention relates to wireless communication.

### Description of the Related Art

Wireless communications have proven useful and are increasing in popularity. Consumers desire increasing wireless communication capabilities. A challenge to service providers is how to provide enhanced services within a limited radio frequency spectrum. One approach for offering high voice and data traffic flow within a single transmission path is to use multiple carriers power amplifier (MCPA) arrangements and multiple transmission paths.

There are various challenges associated with using MCPA arrangements. There are stringent governmental or regulatory out-of-band emission requirements. Additionally, there are in-band considerations. Ideally an ultra-linear characteristic is required to satisfy both types of requirements. In reality, however, high power semi-conductors used for MCPA communications have non-linear performance characteristics. Pre-distortion may be used to address such characteristics.

Pre-distortion techniques typically require a high signal-to-interference ratio and extended bandwidth to allow for correcting high order harmonic distortions. The typical approach is to introduce additional components or circuitry such as a frame level radio frequency isolator to ensure that external interferences like antenna reflection are below a desired threshold. Adding additional devices or circuitry introduces additional loss, uncorrected intermodulation and thermal disadvantages. Accordingly, known approaches are not ideal.

### SUMMARY

An exemplary wireless communication device includes a plurality of amplifiers that each provide an output signal. A combiner combines the output signals into a combined signal. A pre-distortion processor is configured to provide signal correction for each of the amplifiers. The pre-distortion processor receives feedback comprising an indication of each of the output signals before the output signals are combined into the combined signal.

An exemplary wireless communication method includes providing a plurality of output signals. Each output signal is from one of a corresponding plurality of amplifiers. The output signals are combined into a combined signal. An indication of each output signal is obtained before they are combined into the combined signal. Pre-distortion correction is provided for each of the amplifiers based on the obtained indications as feedback.

The various features and advantages of the disclosed examples will become apparent from the following detailed description. The drawings that accompany the detailed description can be briefly described as follows.

### BRIEF DESCRIPTION OF THE DRAWINGS

FIG. 1 schematically illustrates an example wireless communication device designed according to an embodiment of this invention.

FIG. 2 schematically illustrates another example device designed according to an embodiment of this invention.

FIG. 3 is a flowchart diagram summarizing an example approach.

### DETAILED DESCRIPTION

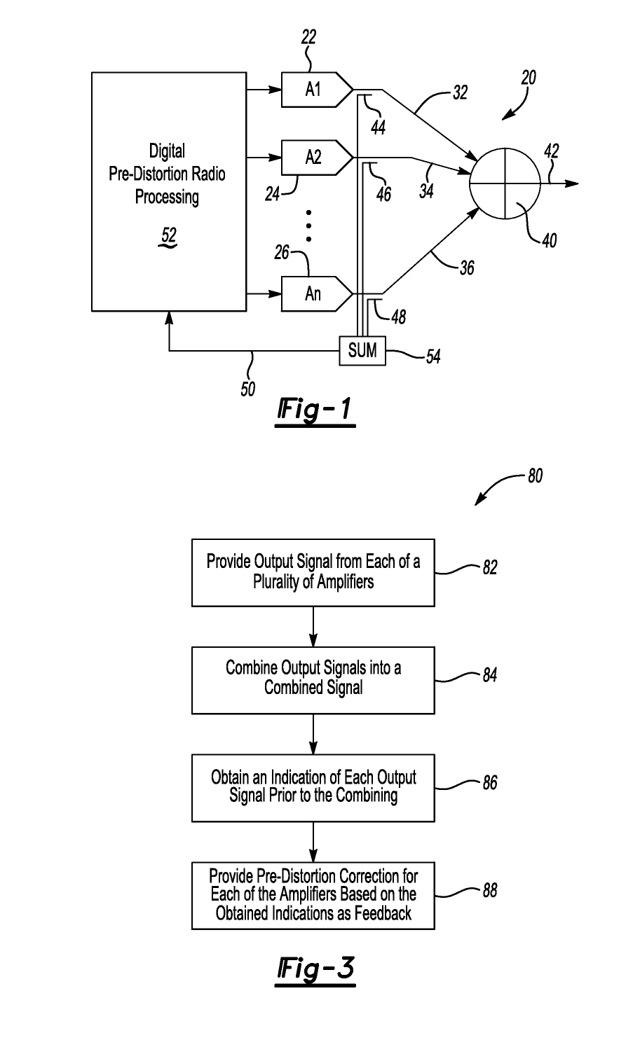

FIG. 1 schematically shows a wireless communication device 20. A plurality of amplifiers 22, 24 and 26 each provide an output signal 32, 34 and 36, respectively. A combiner 40 combines the output signals 32, 34 and 36 to produce a combined signal 42. In some examples, the combiner 40 comprises circuitry or dedicated components that perform the combining In other examples, the combiner 40 comprises a multiple-transmitter air space combining scheme, which does not necessarily require specific combiner hardware or components. In other words, in some examples, the combiner 40 uses air combining of signals such as the output signals 32, 34 and 36.

An RF coupling is associated with each of the amplifiers for obtaining an indication of each of the output signals. An RF coupling 44 is associated with the amplifier 22 for obtaining an indication of the output signal 32. An RF coupling 46 obtains an indication of the output signal 34. An RF coupling 48 obtains an indication of the output signal 36. In the illustrated example, each of the indications of the output signals are obtained before those output signals are combined into the combined signal 42. Utilizing the couplings 44, 46 and 48 offers wider bandwidth for effective distortion correction without any limitation caused by the bandwidth limitations of the combiner 40.

The obtained indications of the output signals are provided as feedback 50 to a digital pre-distortion processor 52. The indications of the output signals provide the feedback 50 that allows the pre-distortion processor to provide signal correction for each of the amplifiers 22, 24 and 26 to address non-linearities, for example, of the amplifiers. The pre-distortion correction allows for a resulting combined signal 42 to have desired characteristics or at least to more closely resemble a combined signal having the desired characteristics. There are known digital pre-distortion techniques. One example embodiment uses such known techniques. The manner in which the feedback 50 is achieved in the example of FIG. 1, however, is different in that the indications of the output signals 32, 34 and 36 are obtained before those signals are combined by the combiner 40 into the combined signal 42. Previous arrangements for providing pre-distortion processing relied upon obtaining feedback from the combined signal 42.

A summer 54 in this example sums the individual feedback signal indications of each output signal and provides a single feedback signal 50 to the pre-distortion processor 52. The sum of the individual feedback signal indications is different than the combined signal 42 because the individual feedback signal indications do not include the losses associated with the combiner 40 and any other components downstream of the amplifiers.

The illustrated example avoids a requirement for introducing additional isolator components downstream of the amplifiers. Such additional isolators tend to introduce additional radio frequency loss, for example. The illustrated example does not have any requirement for providing an additional frame level RF isolator to protect against external interferences. If the combined signal 42 were used for obtaining feedback for the pre-distortion processor 52, such an isolator would be required.

The illustrated example is well suited for MCPA arrangements. In some examples, the output signals 32, 34 and 36 are wirelessly transmitted by the amplifiers and received by the combiner 40. In other words, the example of FIG. 1 uses air combining with feedback indications from the wireless transmissions of the amplifiers before they are combined into a combined signal.

FIG. 2 schematically illustrates an example arrangement of a wireless communication device 20 that is useful as a base station such as a cellular base station transceiver (BTS). In this example, the amplifier 22 includes amplifier circuitry 60 and an isolator 64 that is an existing amplifier output RF isolator. The radio frequency coupling 44 is introduced into the amplifier 22 to take advantage of the already existing isolator 64 to avoid requiring additional isolation apart from the amplifier 22. Similarly, the amplifier 24 includes amplifier circuitry 62 and an isolator 66, which are known components in one example. The radio frequency coupler 46 is introduced into the amplifier 24 to take advantage of the isolation provided by the isolator 66.

In the example of FIG. 2, the combiner 40 and the summer 54 are both realized through a combination module 70, which in one example comprises a tri-band high power combiner. The combiner 40 comprises one portion of the combination module 70 and the summer 54 comprises another portion of that module. As can be appreciated from the illustration, the feedback 50 provided to the pre-distortion processor 52 is based upon an indication of the output signal from each amplifier before those signals are combined by the combiner 40.

The example of FIG. 2 includes a high power radio frequency filter 72 and an antenna 74 for transmitting the combined signal 42. In one example, the antenna 74 is part of an antenna array of a wireless communication base station (BTS). One feature of the example of FIG. 2 is that it also takes advantage of the heat dissipation capabilities of the amplifiers 22 and 24 rather than requiring an additional thermal system external to the amplifiers.

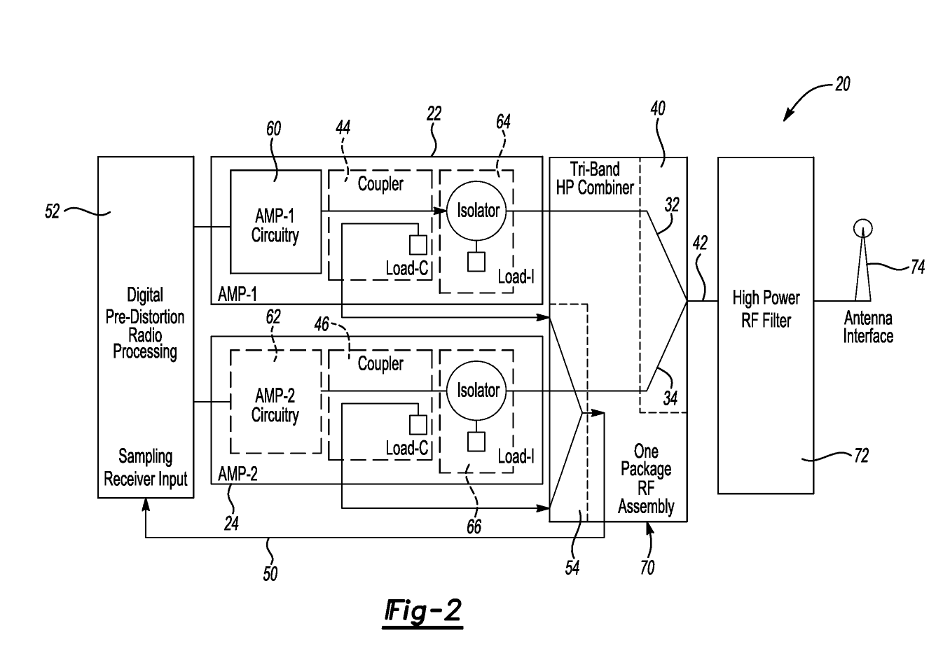

FIG. 3 includes a flowchart diagram 80 that summarizes an example approach. The plurality of amplifiers provide their output signals at 82. The output signals are combined into a combined signal at 84. An indication of each output signal is obtained at 86 prior to those output signals being combined into a combined signal. Pre-distortion correction is provided for each of the amplifiers based on the obtained indications as feedback as shown at 88. The pre-distortion correction is used for adjusting, as necessary, the performance of any of the amplifiers to provide a desired output signal to achieve the results required for a given situation.

Those skilled in the art who have the benefit of this description will be able to select appropriate hardware, software, firmware or a combination of these to realize the various components and functionalities of the illustrated examples.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A wireless communication device, comprising:
a plurality of amplifiers that each provide an output signal;
a combiner that combines the output signals into a combined signal; and
a pre-distortion processor configured to provide signal correction for each of the amplifiers, the pre-distortion processor receiving feedback comprising an indication of each of the output signals before the output signals are combined into the combined signal.

2. The device of claim 1, comprising
a radio frequency coupling associated with each amplifier, each radio frequency coupling providing the feedback indication of the corresponding amplifier output signal to the pre-distortion processor.

3. The device of claim 1, wherein
the output signals are wireless transmitted from the amplifiers; and
the combiner receives the wirelessly transmitted output signals.

4. The device of claim 1, wherein the combiner uses air combining of the output signals.

5. The device of claim 1, comprising
an antenna for transmitting the combined signal.

6. The device of claim 5, wherein the device comprises a wireless communication base station.

7. The device of claim 1, wherein each amplifier comprises a digital pre-distortion coupler that provides the feedback indication for the pre-distortion processor.

8. The device of claim 7, wherein
each amplifier comprises a radio frequency isolator; and
each digital pre-distortion coupler is isolated from outside interference by the corresponding radio frequency isolator.

9. The device of claim 1, comprising
a summer that sums the indications into a feedback signal and provides the feedback signal to the pre-distortion processor.

10. A wireless communication method, comprising the steps of:
providing a plurality of output signals, each output signal being from one of a corresponding plurality of amplifiers;
combining the output signals into a combined signal;
obtaining an indication of each output signal before the combining; and
providing pre-distortion signal correction for each of the amplifiers based on the obtained indications as feedback.

11. The method of claim 10, wherein the obtaining comprises
using a radio frequency coupling associated with each amplifier, each radio frequency coupling providing the indication of the corresponding amplifier output signal.

12. The method of claim 10, comprising
wirelessly transmitting the output signals from the amplifiers; and
receiving the wirelessly transmitted output signals at a combiner.

13. The method of claim 10, comprising using air combining of the output signals.

14. The method of claim 10, comprising
using a digital pre-distortion coupler of each amplifier for providing the corresponding indication.

15. The method of claim 14, wherein
each amplifier comprises a radio frequency isolator and
the method comprises
isolating each digital pre-distortion coupler from outside interference using the corresponding radio frequency isolator.
